(19) United States
(12) Patent Application Publication
(10) Pub. No.: US 2011/0103247 A1
(43) Pub. Date: May 5, 2011

(54) CHANNEL STATUS REPORTING

(75) Inventors: Wanshi Chen, San Diego, CA (US); Tao Luo, San Diego, CA (US); Juan Montojo, San Diego, CA (US); Peter Gaal, San Diego, CA (US)

(73) Assignee: QUALCOMM INCORPORATED, San Diego, CA (US)

(21) Appl. No.: 12/911,942

(22) Filed: Oct. 26, 2010

Related U.S. Application Data
(60) Provisional application No. 61/257,416, filed on Nov. 2, 2009.

(51) Int. Cl. H04W 24/00

(52) U.S. Cl. 370/252

(57) ABSTRACT

Methods, systems, apparatus and computer program products are provided to facilitate the transmission of channel status information in wireless systems, such as advanced long-term evolution (LTE-A) systems. Requests for aperiodic channel status reports are generated in systems that use multiple carriers and operate in multiple-in-multiple-out (MIMO) configurations. The request enables a user equipment to configure two transport blocks for the transmission of channel status information only. In some instances, data, in addition to channel status information, is transmitted by the user equipment.

The present application claims priority to U.S. Provisional Patent Application Ser. No. 61/257,416, entitled “APERIODIC CHANNEL QUALITY INFORMATION REPORT IN LTE-A,” filed Nov. 2, 2009, the entirety of which is hereby incorporated by reference.

### FIELD OF INVENTION

The present invention relates generally to the field of wireless communications and, more particularly, to facilitating the transmission of channel status reports in a wireless communication system.

### BACKGROUND

This section is intended to provide a background or context to the disclosed embodiments. The description herein may include concepts that could be pursued, but are not necessarily ones that have been previously conceived or pursued. Therefore, unless otherwise indicated herein, what is described in this section is not prior art to the description and claims in this application, and is not admitted to be prior art by inclusion in this section.

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal, or user equipment (UE), communicates with one or more base stations through transmissions on the forward and reverse links. The forward link (or downlink) refers to the communication link from the base stations to the user equipment, and the reverse link (or uplink) refers to the communication link from the user equipment to the base stations. This communication link can be established through a single-in-single-out (SISO), multiple-in-single-out (MISO), single-in-multiple-out (SIMO) or a multiple-in-multiple-out (MIMO) system.

One of the features of an LTE system includes the ability to select the downlink transmission configurations and the associated parameters based on the conditions of the downlink. To this end, the base station (i.e., the eNodeB) receives channel status reports from the user equipment that provide estimates of instantaneous downlink conditions. The channel status reporting can be conducted in a periodic manner, which ensures the reception of the channel status reports at certain intervals, or in an aperiodic manner, in which case, an explicit request from the network is required to trigger a channel status report. The aperiodic reports are delivered using the physical uplink shared channel (PUSCH) of the LTE system. While the PUSCH transmissions can include both data and channel status reports, in specific cases, the PUSCH transmissions only include channel status reports with no associated transport data block.

The LTE Release 8 (“LTE Rel-8”) specification only mandates one transmit antenna for the physical uplink shared channel (PUSCH) transmissions. Therefore, only SISO and SIMO configurations are supported in the conventional LTE systems. Further, LTE Rel-8 only mandates a single component carrier waveform on the uplink. As such, the resources on the uplink of a conventional LTE system are allocated in a contiguous manner for each slot of an LTE subframe. It is anticipated that in the LTE-Advanced (“LTE-A”) systems, multiple transmit antennas will be supported for uplink transmissions. This makes it possible to conduct PUSCH transmissions using additional antenna configurations, such as single-user MIMO (SU-MIMO). Further, the requirement of having a single-carrier waveform may be relaxed in LTE-A systems, thus enabling the assignment of non-contiguous resource blocks for uplink transmissions.

The inclusion of these additional features in LTE-A likely requires the development of new downlink control information (DCI) formats for assigning PUSCH transmissions. However, regardless of any particular DCI format, there is a need for methodologies and configurations that enable the transmissions of channel status reports in LTE-A systems that utilize advanced features.

### SUMMARY

This section is intended to provide a summary of certain exemplary embodiments and is not intended to limit the scope of the embodiments that are disclosed in this application.

The disclosed embodiments relate to systems, methods, apparatus and computer program products that facilitate the communication of channel status reports in advanced LTE systems, such as the ones that utilize SU-MIMO and multi-carrier signaling. One aspect of the disclosed embodiments relates to a method that includes configuring two transport blocks for the transmission of information in a wireless communication system in response to a downlink control information message comprising a request for a channel status report. This method also includes transmitting channel status information using at least one of the transport blocks, where the at least one of the transport blocks contains only control information. In one embodiment, the transport blocks are associated with a physical uplink shared channel (PUSCH) of the wireless communication system. In another embodiment, the channel status information comprises at least one of a channel quality indicator (CQI), a rank indicator (RI) and a precoding matrix indicator (PMI).

According to one embodiment, one of the two transport blocks is configured for the transmission of channel status information and the remaining transport block is configured for data transmission. In this embodiment, once the data is transmitted in the remaining transport block, a positive acknowledgment (ACK) or a negative acknowledgment (NACK) is received in response to the transmission of the data. In such a scenario, no acknowledgment is associated with the transmission of channel status information. In another variation, a positive acknowledgment (ACK) or a negative acknowledgment (NACK) is received in response to the transmission of data, in addition to a positive acknowledgment (ACK) that is received in response to the transmission of channel status information. In one example, the channel status information is transmitted using layer shifting.

In another embodiment, one of the two transport blocks is configured for the transmission of channel status information while the remaining transport block is disabled. In this embodiment, no acknowledgment is associated with the transmission of the channel status information.

In a further embodiment, both transport blocks are configured for the transmission of the channel status information. In one variation of this embodiment, no acknowledgment is associated with the transmission of channel status information. According to another embodiment, the request for channel status information is signaled using an indication. This indication can include at least one of the following: a channel quality indicator value, a modulation and coding scheme indicator value, a number of resource blocks that are configured for uplink transmission, a new indicator value, and a redundancy version value. In one example, the number of resource blocks is less than or equal to four resource blocks, whereas in another example, the number of resource blocks is more than four resource blocks.

According to another embodiment, the channel status information is transmitted using a configuration selected from the following configurations: a beam forming configuration, a transmission diversity configuration, a multi-user multiple-input multiple-output (MU-MIMO) configuration, and a single-user multiple-input multiple-output (SU-MIMO) configuration. In still another embodiment, the above-noted method includes determining a first power adjustment value associated with uplink data transmissions, determining a second power adjustment value associated with the channel status information transmissions, and combining the first and the second power adjustment values to produce an overall power adjustment value for uplink transmissions. In another embodiment, the above-noted method further comprises generating a hybrid automatic repeat request (HARQ) feedback in response to data received in a downlink transmission, as well as transmitting the HARQ feedback with the channel status information using the at least on of the transport blocks.

Another aspect of the disclosed embodiments relates to a device that includes a processor and a memory that includes processor executable code. The processor executable code, when executed by the processor, configures the device to configure two transport blocks for transmission of information in a wireless communication system in response to a downlink control information message comprising a request for a channel status report. The processor executable code, when executed by the processor, further configures the device to transmit channel status information using at least one of the transport blocks, where the at least one of the transport blocks contains only control information.

Another aspect of the disclosed embodiments relates to a device that includes means for configuring two transport blocks for transmission of information in a wireless communication system in response to a downlink control information message comprising a request for a channel status report. This device further includes means for transmitting channel status information using at least one of the transport blocks, where the at least one of the transport blocks contains only control information.

In another aspect of the disclosed embodiments a computer program product, embodied on a non-transitory computer readable medium, is provided. The computer program product comprises program code for configuring two transport blocks for transmission of information in a wireless communication system in response to a downlink control information message comprising a request for a channel status report. The computer program product further includes program code for transmitting channel status information using at least one of the transport blocks, where the at least one of the transport blocks contains only control information.

Another aspect of the disclosed embodiments relates to a method that includes generating a request for the transmission of channel status information associated with a user equipment in a wireless communication system. Upon the reception of the request in a downlink control information message, the user equipment is triggered to configure two transport blocks for transmission of the channel status information. The user equipment is further triggered to transmit channel status information using at least one of the transport blocks, where the at least one of the transport blocks contains only control information. The disclosed method also includes transmitting the request to the user equipment.

In one embodiment, the transport blocks are associated with a physical uplink shared channel (PUSCH) of the wireless communication system. In another embodiment, the channel status information comprises at least one of a channel quality indicator (CQI), a rank indicator (RI) and a precoding matrix indicator (PMI). According to still another embodiment, the channel status information is received from a transmission on one of the two transport blocks, whereas the data is received from a transmission on the remaining transport block. In one example, a positive acknowledgment (ACK) or a negative acknowledgment (NACK) is transmitted in response to the reception of data. In this example, no acknowledgment is associated with the reception of channel status information. In another example, a positive acknowledgment (ACK) or a negative acknowledgment (NACK) is transmitted in response to the reception of data. In this example, however, a positive acknowledgment (ACK) is also transmitted in response to the transmission of channel status information. In still another example, the channel status information is transmitted using layer shifting.

According to another embodiment, one of the two transport blocks is configured for the transmission of channel status information and the remaining transport block is disabled. In still another embodiment, both transport blocks are configured for the transmission of channel status information.

In one embodiment, the request is signaled using an indication. This indication can include one or more the following: a channel quality indicator value, a modulation and coding scheme indicator value, a number of resource blocks that are configured for uplink transmission, a new indicator value, and a redundancy version value. In one example, the number of resource blocks is less than or equal to four resource blocks. In another example, the number of resource blocks is more than four resource blocks.

In another embodiment, the channel status information is received using a configuration that is selected from a group of configurations consisting of a beam forming configuration, a transmission diversity configuration, a multi-user multiple-input multiple-output (MU-MIMO) configuration, and a single-user multiple-input multiple-output (SU-MIMO) configuration.

Another aspect of the disclosed embodiments relates to a device that includes a processor and a memory that includes processor executable code. The processor executable code, when executed by the processor, configures the device to generate a request for the transmission of channel status information associated with a user equipment in a wireless communication system. Upon the reception of the request in a downlink control information message, the user equipment is triggered to configure two transport blocks for transmission of the channel status information and transmit channel status information using at least one of the transport blocks, where the at least one of the transport blocks contains only control information. The processor executable code, when executed by the processor, also configures the device to transmit the request to the user equipment.

Another aspect of the disclosed embodiments relates to a device that includes means for generating a request for the transmission of channel status information associated with a user equipment in a wireless communication system. Upon the reception of the request in a downlink control information message, the user equipment is triggered to configure two transport blocks for transmission of the channel status information. The user equipment is further triggered to transmit channel status information using at least one of the transport blocks, where the at least one of the transport blocks contains only control information. The device further includes means transmitting the request to the user equipment.

In another aspect of the disclosed embodiments, a computer program product, embodied on a non-transitory computer readable medium, is provided. The computer program product includes program code for generating a request for the transmission of channel status information associated with a user equipment in a wireless communication system. Upon the reception of the request in a downlink control information message, the user equipment is triggered to configure two transport blocks for transmission of the channel status information, and transmit channel status information using at least one of the transport blocks, where the at least one of the transport blocks contains only control information. The computer program product also includes program code for transmitting the request to the user equipment.

These and other features of the provided embodiments, together with the organization and manner of operation thereof, will become apparent from the following detailed description when taken in conjunction with the accompanying drawings, in which like reference numerals are used to refer to like parts throughout.

### BRIEF DESCRIPTION OF THE DRAWINGS

Various disclosed embodiments are illustrated by way of example, and not of limitation, by referring to the accompanying drawings, in which:

FIG. 1 illustrates a wireless communication system;

FIG. 2 illustrates a block diagram of a communication system;

FIG. 3 is a network within which the disclosed embodiments can be implemented;

FIG. 4 is a frame structure of a long term evolution (LTE) system;

FIG. 5 is an exemplary radio protocol architecture that can be used in conjunction with the disclosed embodiments;

FIG. 6 is a flowchart illustrating the operations of one exemplary embodiment;

FIG. 7 is a flowchart illustrating the operations of another exemplary embodiment;

FIG. 8 illustrates a system within which various embodiments may be implemented; and

FIG. 9 illustrates an apparatus within which various embodiments may be implemented.

### DETAILED DESCRIPTION

In the following description, for purposes of explanation and not limitation, details and descriptions are set forth in order to provide a using understanding of the various disclosed embodiments. However, it will be apparent to those skilled in the art that the various embodiments may be practiced in other embodiments that depart from these details and descriptions.

As used herein, the terms “component,” “module,” “system” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, certain embodiments are described herein in connection with a user equipment. A user equipment can also be called a user terminal, and may contain some or all of the functionality of a system, subscriber unit, subscriber station, mobile station, mobile wireless terminal, mobile device, node, device, remote station, remote terminal, terminal, wireless communication device, wireless communication apparatus or user agent. A user equipment can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with one or more wireless terminals and can also be called, and may contain some or all of the functionality of, an access point, node, wireless node, Node B, evolved NodeB (eNB) or some other network entity. A base station communicates over the air-interface with wireless terminals. The communication may take place through one or more sectors. The base station can act as a router between the wireless terminal and the rest of the access network, which can include an Internet Protocol (IP) network, by converting received air-interface frames to IP packets. The base station can also coordinate management of attributes for the air interface, and may also be the gateway between a wired network and the wireless network.

Various aspects, embodiments or features will be presented in terms of systems that may include a number of devices, components, modules, and the like. It is to be understood and appreciated that the various systems may include additional devices, components, modules, and so on, and/or may not include all of the devices, components, modules and so on, discussed in connection with the figures. A combination of these approaches may also be used.

Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

The various disclosed embodiments may be incorporated into a communication system. In one example, such communication system utilizes an orthogonal frequency division multiplex (OFDM) that effectively partitions the overall system bandwidth into multiple (N_{F}) subcarriers, which may also be referred to as frequency sub-channels, tones or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval, which may be dependent on the bandwidth of each frequency subcarrier, a modulation symbol may be transmitted on each of the N_{F} frequency subcarriers. Thus, OFDM may be used to combat inter-symbol interference (ISI) caused by frequency selective fading, which is characterized by different amounts of attenuation across the system bandwidth.

As noted earlier, communications in the uplink and downlink between the base station and user equipment can be established through a single-in-single-out (SISO), multiple-in-single-out (MISO), single-in-multiple-out (SIMO) or a multiple-in-multiple-out (MIMO) system. A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when multiple antennas are available at the base station.

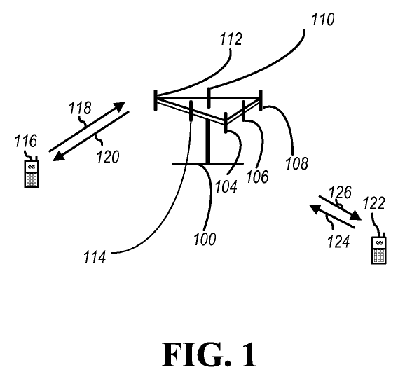

FIG. 1 illustrates a wireless communication system within which the various disclosed embodiments may be implemented. A base station 100 may include multiple antenna groups, and each antenna group may comprise one or more antennas. For example, if the base station 100 comprises six antennas, one antenna group may comprise a first antenna 104 and a second antenna 106, another antenna group may comprise a third antenna 108 and a fourth antenna 110, while a third group may comprise a fifth antenna 112 and a sixth antenna 114. It should be noted that while each of the above-noted antenna groups were identified as having two antennas, more or fewer antennas may be utilized in each antenna group.

Referring back to FIG. 1, a first user equipment 116 is illustrated to be in communication with, for example, the fifth antenna 112 and the sixth antenna 114 to enable the transmission of information to the first user equipment 116 over a first forward link 120, and the reception of information from the first user equipment 116 over a first reverse link 118. FIG. 1 also illustrates a second user equipment 122 that is in communication with, for example, the third antenna 108 and the fourth antenna 110 to enable the transmission of information to the second user equipment 122 over a second forward link 126, and the reception of information from the second user equipment 122 over a second reverse link 124. In a Frequency Division Duplex (FDD) system, the communication links 118, 120, 124 126 that are shown in FIG. 1 may use different frequencies for communication. For example, the first forward link 120 may use a different frequency than that used by the first reverse link 118.

In some embodiments, each group of antennas and/or the area in which they are designed to communicate is often referred to as a sector of the base station. For example, the different antenna groups that are depicted in FIG. 1 may be designed to communicate to the user equipment in a sector of the base station 100. In communication over the forward links 120 and 126, the transmitting antennas of the base station 100 utilize beam forming in order to improve the signal-to-noise ratio of the forward links for the different user equipment 116 and 122. Also, a base station that uses beam forming to transmit to user equipment scattered randomly throughout its coverage area causes less interference to user equipment in the neighboring cells than a base station that transmits omni-directionally through a single antenna to all its user equipment.

The communication networks that may accommodate some of the various disclosed embodiments may include logical channels that are classified into Control Channels and Traffic Channels. Logical control channels may include a broadcast control channel (BCCH), which is the downlink channel for broadcasting system control information, a paging control channel (PCCH), which is the downlink channel that transfers paging information, a multicast control channel (MCCH), which is a point-to-multipoint downlink channel used for transmitting multimedia broadcast and multicast service (MBMS) scheduling and control information for one or several multicast traffic channels (MTCHs). Generally, after establishing radio resource control (RRC) connection, MCCH is only used by the user equipments that receive MBMS. Dedicated control channel (DCCH) is another logical control channel that is a point-to-point bi-directional channel transmitting dedicated control information, such as user-specific control information used by the user equipment having an RRC connection. Common control channel (CCCH) is also a logical control channel that may be used for random access information. Logical traffic channels may comprise a dedicated traffic channel (DTCH), which is a point-to-point bi-directional channel dedicated to one user equipment for the transfer of user information. Also, a multicast traffic channel (MTCH) may be used for point-to-multipoint downlink transmission of traffic data.

The communication networks that accommodate some of the various embodiments may additionally include logical transport channels that are classified into downlink (DL) and uplink (UL). The DL transport channels may include a broadcast channel (BCH), a downlink shared data channel (DL-SDCH), a multicast channel (MCH) and a Paging Channel (PCH). The UL transport channels may include a random access channel (RACH), a request channel (REQCH), an uplink shared data channel (UL-SDCH) and a plurality of physical channels. The physical channels may also include a set of downlink and uplink channels.

In some disclosed embodiments, the downlink physical channels may include at least one of a common pilot channel (CPICH), a synchronization channel (SCH), a common control channel (CCCH), a shared downlink control channel (SDCCH), a multicast control channel (MCCH), a shared uplink assignment channel (SUACH), an acknowledgement channel (ACKCH), a downlink physical shared data channel (DL-PSDCH), an uplink power control channel (UPCCH), a paging indicator channel (PICH), a load indicator channel (LICH), a physical broadcast channel (PBCH), a physical control format indicator channel (PCFICH), a physical downlink control channel (PDCCH), a physical hybrid ARQ indicator channel (PHICH), a physical downlink shared channel (PDSCH) and a physical multicast channel (PMCH). The uplink physical channels may include at least one of a physical random access channel (PRACH), a channel quality indicator channel (CQICH), an acknowledgement channel (ACKCH), an antenna subset indicator channel (ASICH), a shared request channel (SREQCH), an uplink physical shared data channel (UL-PSDCH), a broadband pilot channel (BPICH), a physical uplink control channel (PUCCH) and a physical uplink shared channel (PUSCH).

Further, the following terminology and features may be used in describing the various disclosed embodiments:

| | |
|---|---|
| 3G | 3rd Generation |
| 3GPP | 3rd Generation Partnership Project |
| ACLR | Adjacent channel leakage ratio |
| ACPR | Adjacent channel power ratio |
| ACS | Adjacent channel selectivity |
| ADS | Advanced Design System |
| AMC | Adaptive modulation and coding |
| A-MPR | Additional maximum power reduction |
| ARQ | Automatic repeat request |
| BCCH | Broadcast control channel |
| BTS | Base transceiver station |
| CDD | Cyclic delay diversity |
| CCDF | Complementary cumulative distribution function |
| CDMA | Code division multiple access |
| CFI | Control format indicator |
| Co-MIMO | Cooperative MIMO |
| CP | Cyclic prefix |
| CPICH | Common pilot channel |
| CPRI | Common public radio interface |
| CQI | Channel quality indicator |
| CRC | Cyclic redundancy check |
| DCI | Downlink control indicator |
| DFT | Discrete Fourier transform |
| DFT-SOFDM | Discrete Fourier transform spread OFDM |
| DL | Downlink (base station to subscriber transmission) |
| DL-SCH | Downlink shared channel |
| DSP | Digital signal processing |
| DT | Development toolset |
| DVSA | Digital vector signal analysis |
| EDA | Electronic design automation |
| E-DCH | Enhanced dedicated channel |
| E-UTRAN | Evolved UMTS terrestrial radio access network |
| eMBMS | Evolved multimedia broadcast multicast service |
| eNB | Evolved Node B |
| EPC | Evolved packet core |
| EPRE | Energy per resource element |
| ETSI | European Telecommunications Standards Institute |
| E-UTRA | Evolved UTRA |
| E-UTRAN | Evolved UTRAN |
| EVM | Error vector magnitude |
| FDD | Frequency division duplex |
| FFT | Fast Fourier transform |
| FRC | Fixed reference channel |
| FS1 | Frame structure type 1 |
| FS2 | Frame structure type 2 |
| GSM | Global system for mobile communication |
| HARQ | Hybrid automatic repeat request |
| HDL | Hardware description language |
| HI | HARQ indicator |
| HSDPA | High speed downlink packet access |
| HSPA | High speed packet access |
| HSUPA | High speed uplink packet access |
| IFFT | Inverse FFT |
| IOT | Interoperability test |
| IP | Internet protocol |
| LO | Local oscillator |
| LTE | Long term evolution |
| MAC | Medium access control |
| MBMS | Multimedia broadcast multicast service |
| MBSFN | Multicast/broadcast over single-frequency network |
| MCH | Multicast channel |
| MIMO | Multiple input multiple output |
| MISO | Multiple input single output |
| MME | Mobility management entity |
| MOP | Maximum output power |
| MPR | Maximum power reduction |
| MU-MIMO | Multiple user MIMO |
| NAS | Non-access stratum |
| OBSAI | Open base station architecture interface |
| OFDM | Orthogonal frequency division multiplexing |
| OFDMA | Orthogonal frequency division multiple access |
| PAPR | Peak-to-average power ratio |
| PAR | Peak-to-average ratio |
| PBCH | Physical broadcast channel |
| P-CCPCH | Primary common control physical channel |
| PCFICH | Physical control format indicator channel |
| PCH | Paging channel |
| PDCCH | Physical downlink control channel |
| PDCP | Packet data convergence protocol |
| PDSCH | Physical downlink shared channel |
| PHICH | Physical hybrid ARQ indicator channel |
| PHY | Physical layer |
| PRACH | Physical random access channel |
| PMCH | Physical multicast channel |
| PMI | Pre-coding matrix indicator |
| P-SCH | Primary synchronization signal |
| PUCCH | Physical uplink control channel |
| PUSCH | Physical uplink shared channel. |

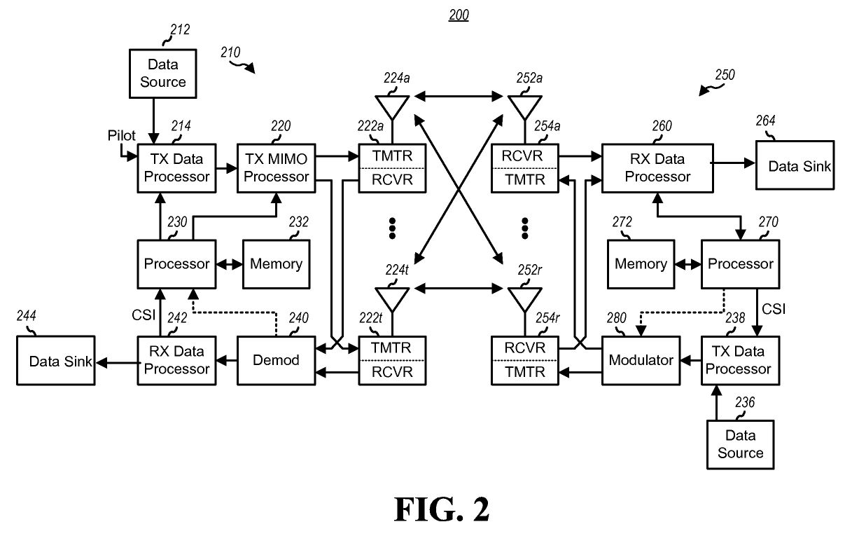

FIG. 2 illustrates a block diagram of an exemplary communication system that may accommodate the various embodiments. The MIMO communication system 200 that is depicted in FIG. 2 comprises a transmitter system 210 (e.g., a base station or access point) and a receiver system 250 (e.g., an access terminal or user equipment) in a MIMO communication system 200. It will be appreciated by one of ordinary skill that even though the base station is referred to as a transmitter system 210 and a user equipment is referred to as a receiver system 250, as illustrated, embodiments of these systems are capable of bi-directional communications. In that regard, the terms “transmitter system 210” and “receiver system 250” should not be used to imply single directional communications from either system. It should also be noted the transmitter system 210 and the receiver system 250 of FIG. 2 are each capable of communicating with a plurality of other receiver and transmitter systems that are not explicitly depicted in FIG. 2. At the transmitter system 210, traffic data for a number of data streams is provided from a data source 212 to a transmit (TX) data processor 214. Each data stream may be transmitted over a respective transmitter system. The TX data processor 214 formats, codes and interleaves the traffic data for each data stream, based on a particular coding scheme selected for that data stream, to provide the coded data.

The coded data for each data stream may be multiplexed with pilot data using, for example, OFDM techniques. The pilot data is typically a known data pattern that is processed in a known manner and may be used at the receiver system to estimate the channel response. The multiplexed pilot and coded data for each data stream is then modulated (symbol mapped) based on a particular modulation scheme (e.g., BPSK, QSPK, M-PSK or M-QAM) selected for that data stream to provide modulation symbols. The data rate, coding and modulation for each data stream may be determined by instructions performed by a processor 230 of the transmitter system 210.

In the exemplary block diagram of FIG. 2, the modulation symbols for all data streams may be provided to a TX MIMO processor 220, which can further process the modulation symbols (e.g., for OFDM). The TX MIMO processor 220 then provides N_{T} modulation symbol streams to N_{T} transmitter system transceivers (TMTR) 222a through 222t. In one embodiment, the TX MIMO processor 220 may further apply beamforming weights to the symbols of the data streams and to the antenna from which the symbol is being transmitted.

Each transmitter system transceiver 222a through 222t receives and processes a respective symbol stream to provide one or more analog signals, and further condition the analog signals to provide a modulated signal suitable for transmission over the MIMO channel. In some embodiments, the conditioning may include, but is not limited to, operations such as amplification, filtering, up-conversion and the like. The modulated signals produced by the transmitter system transceivers 222a through 222t are then transmitted from the transmitter system antennas 224a through 224t that are shown in FIG. 2.

At the receiver system 250, the transmitted modulated signals may be received by the receiver system antennas 252a through 252r, and the received signal from each of the receiver system antennas 252a through 252r is provided to a respective receiver system transceiver (RCVR) 254a through 254r. Each receiver system transceiver 254a through 254r conditions a respective received signal, digitizes the conditioned signal to provide samples and may further processes the samples to provide a corresponding “received” symbol stream. In some embodiments, the conditioning may include, but is not limited to, operations such as amplification, filtering, down-conversion and the like.

An RX data processor 260 then receives and processes the symbol streams from the receiver system transceivers 254a through 254r based on a particular receiver processing technique to provide a plurality of “detected” symbol streams. In one example, each detected symbol stream can include symbols that are estimates of the symbols transmitted for the corresponding data stream. The RX data processor 260 then, at least in part, demodulates, de-interleaves and decodes each detected symbol stream to recover the traffic data for the corresponding data stream. The processing by the RX data processor 260 may be complementary to that performed by the TX MIMO processor 220 and the TX data processor 214 at the transmitter system 210. The RX data processor 260 can additionally provide processed symbol streams to a data sink 264.

In some embodiments, a channel response estimate is generated by the RX data processor 260 and can be used to perform space/time processing at the receiver system 250, adjust power levels, change modulation rates or schemes, and/or other appropriate actions. Additionally, the RX data processor 260 can further estimate channel characteristics such as signal-to-noise (SNR) and signal-to-interference ratio (SIR) of the detected symbol streams. The RX data processor 260 can then provide estimated channel characteristics to a processor 270. In one example, the RX data processor 260 and/or the processor 270 of the receiver system 250 can further derive an estimate of the “operating” SNR for the system. The processor 270 of the receiver system 250 can also provide channel state information (CSI) (also referred to a channel status information in some embodiments), which may include information regarding the communication link and/or the received data stream. This information, which may contain, for example, the operating SNR and other channel information, may be used by the transmitter system 210 (e.g., base station or eNodeB) to make proper decisions regarding, for example, the user equipment scheduling, MIMO settings, modulation and coding choices and the like. At the receiver system 250, the CSI that is produced by the processor 270 is processed by a TX data processor 238, modulated by a modulator 280, conditioned by the receiver system transceivers 254a through 254r and transmitted back to the transmitter system 210. In addition, a data source 236 at the receiver system 250 can provide additional data to be processed by the TX data processor 238.

In some embodiments, the processor 270 at the receiver system 250 may also periodically determine which pre-coding matrix to use. The processor 270 formulates a reverse link message comprising a matrix index portion and a rank value portion. The reverse link message may comprise various types of information regarding the communication link and/or the received data stream. The reverse link message is then processed by the TX data processor 238 at the receiver system 250, which may also receive traffic data for a number of data streams from the data source 236. The processed information is then modulated by a modulator 280, conditioned by one or more of the receiver system transceivers 254a through 254r, and transmitted back to the transmitter system 210.

In some embodiments of the MIMO communication system 200, the receiver system 250 is capable of receiving and processing spatially multiplexed signals. In these systems, spatial multiplexing occurs at the transmitter system 210 by multiplexing and transmitting different data streams on the transmitter system antennas 224a through 224t. This is in contrast to the use of transmit diversity schemes, where the same data stream is sent from multiple transmitter systems antennas 224a through 224t. In a MIMO communication system 200 capable of receiving and processing spatially multiplexed signals, a precode matrix is typically used at the transmitter system 210 to ensure the signals transmitted from each of the transmitter system antennas 224a through 224t are sufficiently decorrelated from each other. This decorrelation ensures that the composite signal arriving at any particular receiver system antenna 252a through 252r can be received and the individual data streams can be determined in the presence of signals carrying other data streams from other transmitter system antennas 224a through 224t.

Since the amount of cross-correlation between streams can be influenced by the environment, it is advantageous for the receiver system 250 to feed back information to the transmitter system 210 about the received signals. In these systems, both the transmitter system 210 and the receiver system 250 contain a codebook with a number of precoding matrices. Each of these precoding matrices can, in some instances, be related to an amount of cross-correlation experienced in the received signal. Since it is advantageous to send the index of a particular matrix rather than the values in the matrix, the feedback control signal sent from the receiver system 250 to the transmitter system 210 typically contains the index of a particular precoding matrix (i.e., the precoding matrix indicator (PMI)). In some instances the feedback control signal also includes a rank indicator (RI), which indicates to the transmitter system 210 how many independent data streams to use in spatial multiplexing.

Other embodiments of MIMO communication system 200 are configured to utilize transmit diversity schemes instead of the spatially multiplexed scheme described above. In these embodiments, the same data stream is transmitted across the transmitter system antennas 224a through 224t. In these embodiments, the data rate delivered to receiver system 250 is typically lower than spatially multiplexed MIMO communication systems 200. These embodiments provide robustness and reliability of the communication channel. In transmit diversity systems each of the signals transmitted from the transmitter system antennas 224a through 224t will experience a different interference environment (e.g., fading, reflection, multi-path phase shifts). In these embodiments, the different signal characteristics received at the receiver system antennas 252a through 254r are useful in determining the appropriate data stream. In these embodiments, the rank indicator is typically set to 1, telling the transmitter system 210 not to use spatial multiplexing.

Other embodiments may utilize a combination of spatial multiplexing and transmit diversity. For example in a MIMO communication system 200 utilizing four transmitter system antennas 224a through 224t, a first data stream may be transmitted on two of the transmitter system antennas 224a through 224t and a second data stream transmitted on remaining two transmitter system antennas 224a through 224t. In these embodiments, the rank index is set to an integer lower than the full rank of the precode matrix, indicating to the transmitter system 210 to employ a combination of spatial multiplexing and transmit diversity.

At the transmitter system 210, the modulated signals from the receiver system 250 are received by the transmitter system antennas 224a through 224t, are conditioned by the transmitter system transceivers 222a through 222t, are demodulated by a transmitter system demodulator 240, and are processed by the RX data processor 242 to extract the reserve link message transmitted by the receiver system 250. In some embodiments, the processor 230 of the transmitter system 210 then determines which pre-coding matrix to use for future forward link transmissions, and then processes the extracted message. In other embodiments, the processor 230 uses the received signal to adjust the beamforming weights for future forward link transmissions.

In other embodiments, a reported CSI can be provided to the processor 230 of the transmitter system 210 and used to determine, for example, data rates as well as coding and modulation schemes to be used for one or more data streams. The determined coding and modulation schemes can then be provided to one or more transmitter system transceivers 222a through 222t at the transmitter system 210 for quantization and/or use in later transmissions to the receiver system 250. Additionally and/or alternatively, the reported CSI can be used by the processor 230 of the transmitter system 210 to generate various controls for the TX data processor 214 and the TX MIMO processor 220. In one example, the CSI and/or other information processed by the RX data processor 242 of the transmitter system 210 can be provided to a data sink 244.

In some embodiments, the processor 230 at the transmitter system 210 and the processor 270 at the receiver system 250 may direct operations at their respective systems. Additionally, a memory 232 at the transmitter system 210 and a memory 272 at the receiver system 250 can provide storage for program codes and data used by the transmitter system processor 230 and the receiver system processor 270, respectively. Further, at the receiver system 250, various processing techniques can be used to process the N_{R} received signals to detect the N_{T} transmitted symbol streams. These receiver processing techniques can include spatial and space-time receiver processing techniques, which can include equalization techniques, “successive nulling/equalization and interference cancellation” receiver processing techniques, and/or “successive interference cancellation” or “successive cancellation” receiver processing techniques.

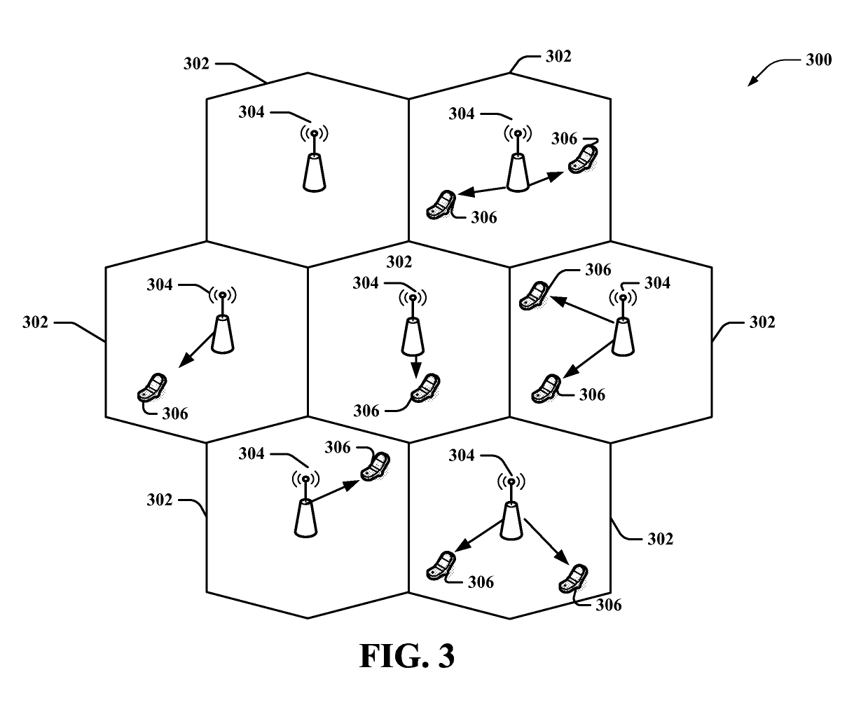

FIG. 3 illustrates an exemplary access network in an LTE network architecture that can be used in conjunction with the disclosed embodiments. In this example, the access network 300 is divided into a number of cellular regions (cells) 302. An eNodeB 304 is assigned to a cell 302 and is configured to provide an access point to a core network for all the UEs 306 in the cell 302. There is no centralized controller in this example of an access network 300, but a centralized controller may be used in alternative configurations. In other configurations, one eNodeB 304 may control the operations of a plurality of cells 302. The eNodeB 304 is responsible for all radio related functions including radio bearer control, admission control, mobility control, scheduling, security, and connectivity to the serving gateway in a core network.

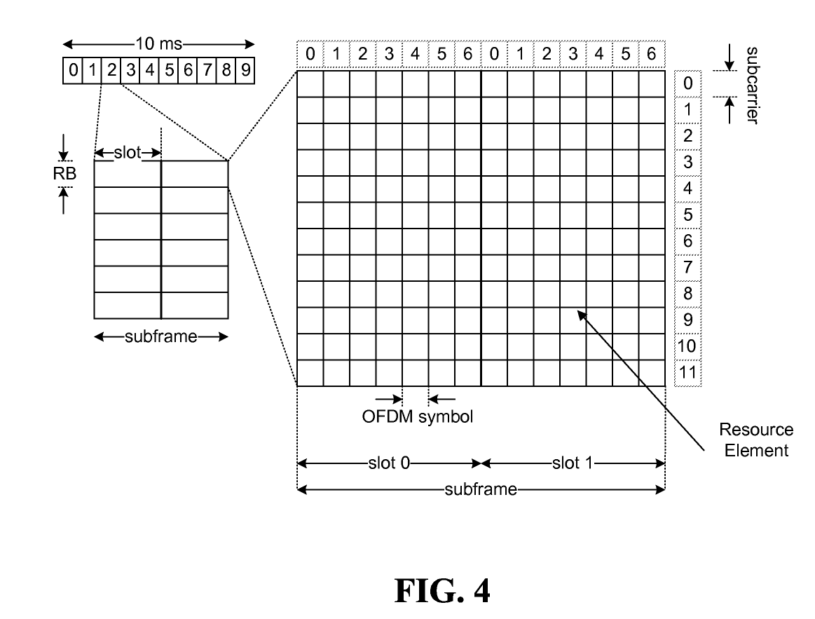

A wireless network, such as the LTE network 300 of FIG. 3, may use various frame structures to support the uplink and downlink transmissions. FIG. 4 illustrates an exemplary frame structure of an LTE system. However, as those skilled in the art will readily appreciate, the frame structure for any particular application may be different depending on any number of factors. In this example, a frame (10 ms) is divided into 10 equally sized sub-frames. Each sub-frame includes two consecutive time slots. A resource grid may be used to represent two time slots, each slot including a resource block. The resource grid is divided into multiple resource elements. In LTE systems, a resource block contains 12 consecutive subcarriers in the frequency domain. When normal cyclic prefix is used, each resource block contains seven consecutive OFDM symbols (downlink) or SC-FDMA symbols (uplink) in the time domain (as illustrated in FIG. 4). When extended cyclic prefix is used, each resource block comprises six consecutive OFDM symbols (downlink) or SC-FDMA symbols (uplink) in the time domain. As such, a resource block that uses symbols with normal prefix contains 84 resource elements, whereas a resource block with extended cyclic prefix includes 72 resource elements. The number of bits carried by each resource element depends on the modulation scheme.

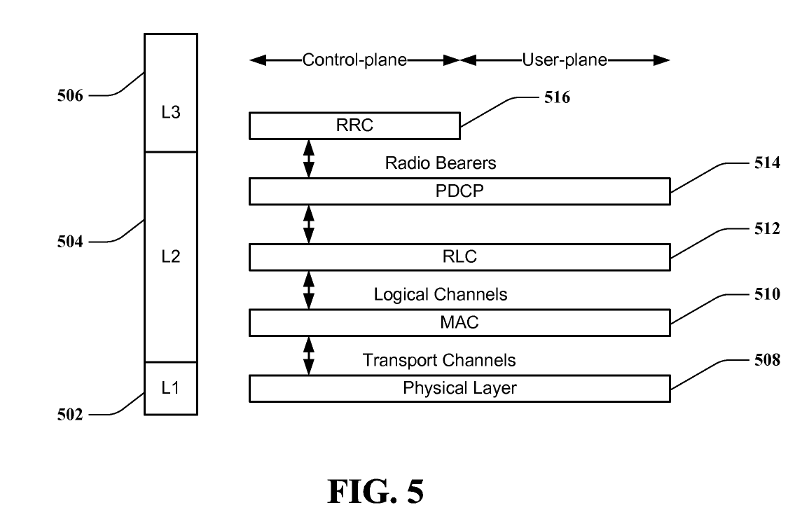

FIG. 5 illustrates an exemplary radio protocol architecture for the user and the control planes that can be utilized in systems that accommodate the disclosed embodiments. FIG. 5 shows the radio protocol architecture for the user equipment and eNodeB with three layers: Layer 1 502, Layer 2 504, and Layer 3 506. Layer 1 502 is the lowest lower and implements various physical layer signal processing functions. Layer 1 502 will be referred to herein as the physical layer 508. Layer 2 (L2 layer) 504 is above the physical layer 508 and is responsible for the link between the user equipment and eNodeB over the physical layer 508. In the user plane, the L2 layer 504 includes a media access control (MAC) sublayer 510, a radio link control (RLC) sublayer 512, and a packet data convergence protocol (PDCP) 514 sublayer, which are terminated at the eNodeB on the network side. Although not shown, the user equipment may have several upper layers above the L2 layer 504 including a network layer (e.g., IP layer) and an application layer.

The PDCP sublayer 514 can provide multiplexing between different radio bearers and logical channels. The PDCP sublayer 514 also provides header compression for upper layer data packets to reduce radio transmission overhead, security by ciphering the data packets, and handover support for UEs between eNodeBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the user equipment. The MAC sublayer 510 is also responsible for HARQ operations.

In the control pane, the radio protocol architecture for the UE and eNodeB is substantially the same for the physical layer 508 and the L2 layer 504 with the exception that there is no header compression function for the control plane. The control pane also includes a radio resource control (RRC) sublayer 516 in Layer 3. The RRC sublayer 516 is responsible for obtaining radio resources (i.e., radio bearers) and for configuring the lower layers using RRC signaling between the eNodeB and the user equipment.

As noted earlier, in LTE systems periodic and aperiodic channel status reports provide information about the channel conditions to the eNodeB. The aperiodic channel status report can include parameters such as channel quality indicator (CQI), precoding matrix indication (PMI) and rank indictor (RI). The CQI represents the recommended modulation scheme and coding rate that should preferably be used for downlink transmissions. The CQI typically provides an index to a table with pre-defined modulation scheme and coding rate combinations. As was discussed earlier in the context of spatial multiplexing, the PMI provides an index to the precoder matrix for downlink transmissions, and the RI provides the recommended number of independent data streams to used in spatial multiplexing for downlink transmissions to the user equipment.

The aperiodic reporting can be triggered in response to a specific request from the eNodeB or by a random access response (RAR) grant. In initiating a request for a channel status report, the eNodeB uses physical downlink control channel (PDCCH) format 0. In format 0, a single bit can be set to act as a trigger for aperiodic channel status report. Since such a trigger for the aperiodic report is included in the uplink scheduling grant, the user equipment, in the majority of cases, has the available resources for the uplink transmission of the status report on the PUSCH. A user equipment can be semi-statically be configured by higher levels (e.g., by Layer 3) to provide the channel status report that includes the CQI, the PMI and the corresponding RI. The reporting of the CQI, PMI and RI depends on the transmission mode of the user equipment. For example, the PMI and the RI are only reported when spatial multiplexing is used. Moreover, different combinations of CQI, PMI and RI may be reported based on the different reporting modes. Table 1 illustrates some of the reporting modes and the associated CQI and PMI feedback types.

TABLE 1
Feedback Types for Different PUSCH Reporting Modes

| | PMI Feedback Type | | |
|---|---|---|---|
| PUSCH CQI | | Single | Multiple |
| Feedback Type | No PMI | PMI | PMI |
| Wideband | | | Mode 1-2 |
| (wideband CQI) | | | |
| UE Selected | Mode 2-0 | | Mode 2-2 |
| (subband CQI) | | | |
| Higher Layer- | Mode 3-0 | Mode 3-1 | |
| configured | | | |
| (subband CQI) | | | |

The wideband CQI is the feedback provided by the user equipment that includes a single CQI for the entire system bandwidth. In the case of user equipment selected feedback, the user equipment selects a set of preferred subbands within the system bandwidth and provides the CQI for the selected subbands. In the higher layer-configured subband CQI, the user equipment typically reports a wideband CQI in addition to the CQIs that are reported for each subband. This subband configuration may be carried out by the higher levels. It should be noted that in LTE Rel-8 systems, aperiodic reporting modes are not supported for systems that utilize less than eight resource blocks in the downlink (i.e., N_{RB}^{DL}≦7).

Each PUSCH transmission is associated with a modulation and coding scheme (MCS), which is represented by a 5-bit field that corresponds to the index I_{MCS}ε{0, 1, . . . , 31}. This field, which is carried in the PDCCH DCI format 0, in RAR grant, etc., can provide the user equipment with information about the modulation rate, coding rate and the transport block size. If I_{MCS}=29, the “CQI request” bit in PDCCH DCI format 0 is set to 1, and the number of physical resource blocks (PRB) scheduled for PUSCH is less than or equal to 4, then there is no transport data block for the uplink shared channel (UL-SCH). As such, only the control information feedback for the current aperiodic CQI reporting mode is transmitted by the user equipment. This configuration is sometimes referred to as the “CQI-only” transmission. It should, however, be understood that, in the context of the disclosed embodiments, such transmissions can include other implicit channel status report information, such as the PMI and the RI, and/or explicit channel feedback, such as the channel covariance matrix). Therefore, in the context of the disclosed embodiment, the term channel status information-only (“CSI-only”) will be used to refer to such transmissions. The modulation order for the CSI-only transmission can be fixed at 2 (i.e., Quadrature Phase Shift Keying “QPSK” modulation scheme).

As noted earlier, in LTE Rel-8 systems only SIMO configuration is supported for PUSCH transmissions. Further, the LTE Rel-8 specification only mandates single-carrier operation on the downlink. In contrast, in LTE-A systems, multiple transmit antennas can be used in the uplink and multiple carrier operations are supported. In LTE-A, DCI format 0 (or a slightly revised version) may still be supported. However, to accommodate the new features of LTE-A, new DCI formats may also be developed to schedule uplink transmissions using PUSCH. Nonetheless, there are no provisions in LTE-A that describe how the CSI-only transmissions can be effected in systems that use these advanced features.

The disclosed embodiments facilitate CSI-only transmissions in LTE-A systems. In particular, the provided embodiments enable CSI-only transmissions that can be applied to all revised and/or new DCI formats for scheduling uplink transmissions. Further, some of the disclosed embodiments can be specifically tailored to operate in conjunction with particular DCI formats.

In LTE systems, data on a transport channel is organized as a transport block, which corresponds to a group of resource blocks with a common modulation/coding. Each transport block is transmitted during a particular transmission time interval (TTI). Typically, one transport block is transmitted over a TTI, unless spatial multiplexing is used, in which case up to two transport blocks can be transmitted per TTI. For example, in Rel-8 and Rel-9 systems, the PDCCH formats 2, 2A, and 2B use two transport blocks in the downlink. Similarly, in LTE-A systems, two transport blocks can be supported in the DCI scheduling of uplink transmissions. According to one embodiment, a CSI-only transmission may be enabled on a per-transport-block (or equivalently, per-codeword) basis. A codeword is an independently encoded data block that corresponds to a single transport block. As such, the terms codeword and transport block may be used interchangeably in the sections that follow. It should be also noted that such codewords or transport blocks are typically protected by a CRC and are delivered from the medium access control (MAC) layer to the physical layer.

The disclosed embodiments enable CSI-only transmissions using multiple transport blocks. Table 2 summarizes exemplary transport block configurations that are produced in accordance with the disclosed embodiments. In particular, configuration A enables the CSI-only transmission in transport block 1 (i.e., the first transport block). Configuration B enables the CSI-only transmissions in transport block 2 (i.e., the second transport block), and configuration C enables the CSI-only transmissions in both transport blocks 1 and 2. It should be noted that when configurations A or B are utilized, the transport block that is not used for CSI-only transmission, can be enabled for data transmission. Alternatively, when configurations A or B are used, the transport block that is not associated with CSI-only transmission can be disabled (e.g., no remaining data for transmission exists). In such a scenario, the DCI corresponds only the CSI-only transmission in one transport block.

TABLE 2
Transport Block Configurations for CSI-Only Transmission

| Configuration | Transport Block 1 | Transport Block 2 |
|---|---|---|
| A | CSI-Only | DATA enabled |
| | CSI-Only | DATA disabled |
| B | DATA enabled | CSI-Only |
| | DATA disabled | CSI-Only |
| C | CSI-Only | CSI-Only |

It should be noted that Table 2 provides a non-exhaustive list of exemplary transport block configurations. Therefore, additional transport block configurations can be implemented in accordance with the disclosed embodiments. For example, in one variation, transport block 1 is configured to carry CQI and PMI (and potentially data), whereas transport block 2 is configured to carry data. In another example, both transport blocks 1 and 2 can be configured to carry both data and RI.

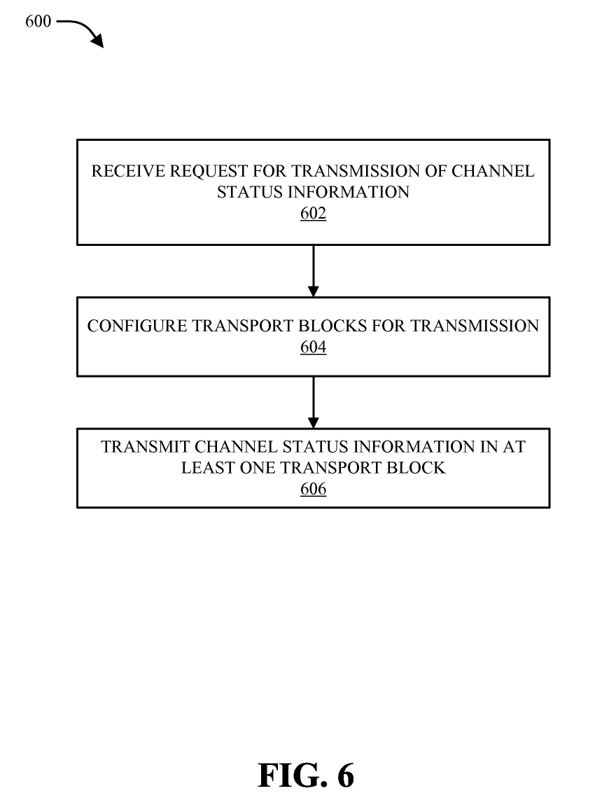

FIG. 6 is a block diagram illustrating a process 600 for transmitting channel status information in accordance with an exemplary embodiment. At 602, a request for channel status report is received. For example, an eNodeB can signal a request to a user equipment, in a downlink control information message, for an aperiodic channel status report. At 604, two transport blocks are configured for the transmission of channel status information and/or data. For example, any one of the above-described configurations A through C (or variations thereof) can be used to enable uplink transmission of CSI/data on PUSCH. At 606, the channel status information is transmitted in at least one of the transport blocks. In particular, the transport block(s) used for the transmission of the channel status information may contain only control information. As noted earlier, the channel status information can include CQI, PMI, RI and other information. Further, the user equipment may also generate a hybrid automatic repeat request (HARQ) feedback in response to downlink data transmissions. The HARQ feedback can include a positive acknowledgment (ACK) or a negative acknowledgment (NACK) to trigger the retransmission of data blocks that were not successfully received. In such a scenario, the HARQ feedback can be transmitted with the channel status information as part of the same transport block(s).

The user equipment can be signaled to provide the CSI report through an appropriate indication. According to one embodiment, an indication of CSI-only transmission can be produced by setting a CSI request bit to “1” (e.g., in a particular DCI format such as format 0), setting the I_{MCS} to a particular value (e.g., 29), and scheduling a particular number of PRBs for PDUSCH transmissions (e.g., number of PRBs≦4). Under such conditions, one or both of the transport blocks can be configured for CSI-only transmission using one of the above-described configuration options. In such scenarios, the same number of PRBs are configured for the two transport blocks. As such, if one transport block is activated for CSI-only transmission with less than equal to four PRBs, while the other transport block is used for data transmission, the resource allocation size for data transmission is also no more than four PRBs.

In other embodiments, additional or alternate indications may be used for signaling a CSI-only transmission. In particular, each transport block has its own MCS, new data indicator (NDI) and redundancy version (RV) fields. As such, a combination of one or more of the above three fields, and potentially with an additional limitation on the number of PRBs, can be used for indicating a request for CSI-only transmission.

Note that, however, with four PRBs and 144 resource elements per PRB (form normal cyclic prefix), only 576 resource elements are allocated for each transport block. Analogously, with four PRBs and 120 resource elements per PRB, 480 resource elements are allocated for each transport block when extended cyclic prefix is used. With QPSK modulation and a target coding rate of, for example, no lower than 1/6, the number of available bits (including CRC) is at most (576)×(2/6)=192 or (480)×(2/6)=160 bits for normal and extended cyclic prefix subframes, respectively. These bits generally provide sufficient capacity for CSI transmissions. However, in certain complex scenarios (e.g., when supporting coordinated multipoint MIMO schemes where multiple cells cooperate to improve the overall operational efficiency), more bits may be needed to convey the CSI reports. In these scenarios, according to one embodiment, a lager number of PRBs are configured for CSI-only transmissions. Additionally, or alternatively, the signaling capacity for CSI-only transmissions can be extended by utilizing time-domain repetition. In one example, time-domain repetition can include bundling of a fixed number of subframes (e.g., 4 subframes). The indication of time-domain repetition can be enabled through layer-3 or layer-2 signaling.

In LTE Rel-8 systems, the physical hybrid ARQ indicator channel (PHICH) carries a positive acknowledgment (ACK) and/or a negative acknowledgement (NACK), which indicate whether or not the eNodeB has properly received the PUSCH transmissions. The disclosed embodiments further enable the transmission of such acknowledgements for systems that utilize multiple transport blocks for CSI-only transmission. In particular, in configuration C of Table 2, where both transport blocks are configured for CSI-only transmissions, no ACK/NACK transmissions are produced. Similarly, in configurations A and B of Table 2 where the non-CSI-only transport block is disabled, no ACK/NACK transmissions are needed.

On the other hand, in configurations A and B of Table 2 where the non-CSI-only transport block is enabled for data transmission, two different options can be utilized. In one option, the CSI-only and data are independently transmitted, and the ACK/NACK transmissions on PHICH correspond to the data transport block only. In another option, layer shifting is used to allow the transmission of transport blocks using multiple layers. Note that a layer is one of several streams that are generated in spatial multiplexing systems, where a transport block (or a codeword) can be mapped to one or more available layers. In such systems, the ACK/NACK transmissions on PHICH correspond to only the data portion of the transmission. As such, with this option, the data portion of the transmission may be de-interleaved from the multiple layers in order to assess whether an ACK or a NACK should be transmitted. In one variation, where layer shifting is used, in addition to transmitting the ACK/NACK for the data transport block, an ACK is always transmitted for the CSI-only transport block.

As noted earlier, a transport block can be mapped to one or more layers. In MIMO systems, a single transport block can be mapped to all available layers, or multiple transport blocks can each be mapped to one or more different layers. In the context of CSI-only transmissions that are implemented in accordance with the disclosed embodiments, the CSI-only transport blocks can be mapped to one layer or two layers, depending on eNodeB scheduling decisions. In one example, when one codeword is used for CSI-only transmission, only one layer is supported.

In systems that use multiple component carriers, multiple uplink carriers can require ACK/NACK feedbacks that are transmitted using one downlink carrier (e.g., multiple PUSCH are mapped on one PHICH for the purpose of ACK/NACK responses). According to the disclosed embodiments, if one or more PUSCH transmissions contain CSI-only transmissions, these PUSCH transmissions are discounted from the PHICH mapping (i.e., for either multiplexing or bundling scenarios). Alternatively, the PUSCH with CSI-only transmissions can be mapped to the PHICH with an ACK for each CSI-only transmission.

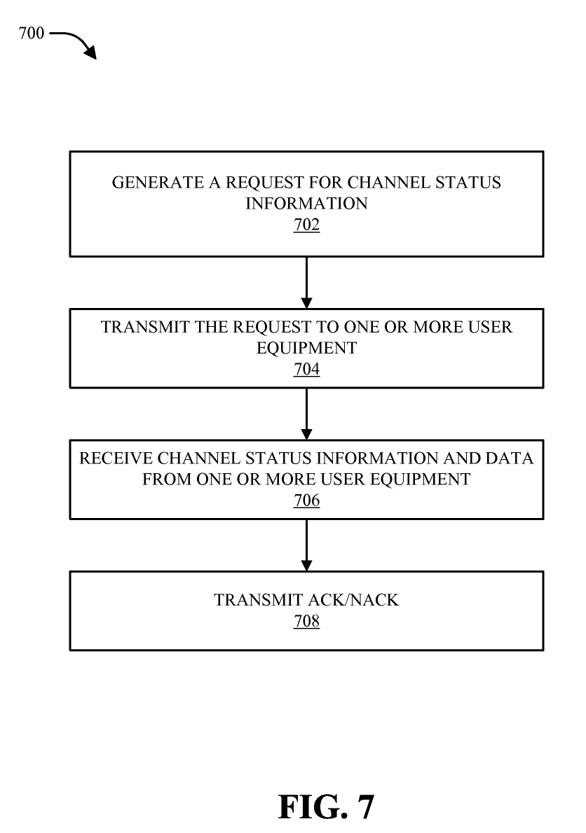

FIG. 7 illustrates a process 700 for generating a request for channel status information and responding to the received channel status information according to an exemplary embodiment. The process 700 of FIG. 7 can, for example, be implemented at an eNodeB that is in communication with one or more user equipment. At 702, a request for channel status information is generated. As noted earlier, this request can include setting certain bits of a DCI format, setting a modulation and coding index to a particular value and/or limiting the number of resource blocks to a certain number. At 704, the generated request is transmitted in a downlink information message to one or more user equipment. This transmission can, for example, be communicated using a PDCCH of an LTE system. The request that is received at a user equipment, configures two transport blocks for transmitting the channel status information and potentially data in an uplink transmission. At 706, one or more channel status information (as part of one or more channel status reports) is received. The channel status information can, for example, include a CQI, a PMI and/or an RI and may be transmitted in a transport block that contains only control information. Upon the reception of the channel status information, an acknowledgment (ACK) or a negative acknowledgment (NACK) is transmitted to the user equipment at 708. As noted earlier, in some embodiments, only the data portion of the received transmission (if any) is acknowledged. In other embodiments, an ACK is also transmitted for the channel status information portion of the received transmission.

In LTE Rel-8 systems, due to the fact that only one transmit antenna is mandatory on the uplink, SIMO transmission is assumed for all PUSCH transmissions. In LTE-A systems, however, multiple uplink antennas can be supported, which enables data transmissions on PUSCH with transmit diversity, beam forming, SU-MIMO and the like. The CSI-only transmissions that are carried out according to the disclosed embodiments can be supported by systems that utilize beam forming, transmission diversity (e.g., space frequency block code (SFBC), frequency switched transmit diversity (FSTD), cyclic delay diversity (CDD), etc.), which can be transparent to the eNodeB. The CSI-only transmissions can also be configured for MU-MIMO systems, where multiple layers are configured for use with multiple users. Further, the CSI-only transmissions can be utilized in SU-MIMO configurations.

Another aspect of the disclosed embodiments relates to implementing adjustments in the uplink power control. In LTE Rel-8 systems, uplink power control for PUSCH can be adjusted based on the transport format. This uplink power adjustment, Δ_{TF}, in subframe, i, is given by the following expression.

Δ_{TF}(i)=10 log₁₀((2^{MPR-K}^{_{S}}−1)β_{offset}^{PUSCH}), for K_{S}=1.25;

Δ_{TF}(i)=0, for K_{S}=0. (1)

In the above expression β_{offset}^{PUSCH}=β_{offset}^{CQI} for control data that is sent via PUSCH without UL-SCH, and is equal to 1 in all other cases. β_{offset}^{CQI} is a UE-specific offset value configured by higher layers (e.g., Layer 3). K_{S} is given by the user equipment specific parameter deltaMCS-enabled, which is provided by higher layers (e.g., Layer 3). In addition, MPR, for control data sent via PUSCH without UL-SCH data, is given by:

$$M P R = \frac{{O}_{CQI}}{{N}_{RE}} . \qquad ( 2 )$$

In Equation (2), O_{CQI} is the number of CSI bits including CRC bits, and N_{RE} is the number of resource elements determined as N_{RE}=M_{SC}^{PUSCH-itinial}·N_{symb}^{PUSCH-itinial}. MPR, for cases other than where control data is sent via PUSCH without UL-SCH data, is given by:

$$M P R = {\sum }_{r = 0}^{C - 1} \frac{{K}_{r}}{{N}_{RE}} . \qquad ( 3 )$$

In Equation (3), Kᵣ is the size for code block r and C is the number of code blocks. M_{SC}^{PUSCH-itinial} is the scheduled bandwidth for transmission obtained from the initial PDCCH for the same transport block, and N_{SC}^{PUSCH-itinial} is the number of SC-FDMA symbols per subframe for initial transmission of the transport block.

In scenarios where multiple transport blocks are used to transmit channel status information and potentially data, the power adjustment that is represented by Equation (1) must also be modified to account for the new transport block configurations. The disclosed embodiments further facilitate power control for systems that utilize two or more transport blocks for the transmission of CSI and data. In particular, power control adjustments are generated that are a function of one or more of the following: O_{CQI}, C and/or Kᵣ (for cases where one transport block is used for UL-SCH), β_{offset}^{CQI}, the number of layers used for CSI-only transmission, the number of codewords used for CSI-only transmission, the particular PUSCH transmission scheme used, and the like. In one example embodiment, where one transport block is used for CSI-only transmission and the other transport block is used for data transmissions, the uplink power adjustment, Δ_{TF}, provided by:

$${Δ}_{TF} ( i ) = 10 {log}_{10} ( ( {2}^{( {O}_{CQI} / {N}_{RE} ) \cdot {K}_{S}} - 1 ) {β}_{offset}^{CQI} ) + 10 {log}_{10} ( {2}^{( {\sum }_{r = 0}^{C - 1} \frac{{K}_{r}}{{N}_{RE}} ) \cdot {K}_{S}} - 1 ) . \qquad ( 4 )$$

In Equation (4), the first term on the right-hand side accounts for the CSI-only transmission on one transport block, while the second term on the right-hand side corresponds to the data transmission on the other transport block. Therefore, the power adjustments for the data and CSI transmissions can be adjusted separately and ultimately added together to provide an overall power adjustment value.

It should be noted that, in some instances, a periodic and an aperiodic CSI may be collide (i.e., scheduled to be transmitted in one subframe). In these situations, the periodic CSI can be dropped (i.e., not transmitted). In other instances when a scheduling request (SR) collides with aperiodic CSI on PUSCH in one subframe, SR should be carried as part of MAC payload (e.g., as part of a reserved field). In other scenarios, where ACK/NACK responses that are produced by the user equipment and transmitted on PUSCH, the CSI-only transmissions can be multiplexed with PUSCH transmissions. In one example, the ACK/NACK can be multiplexed with the transport blocks that carry the CQI-only information. In another example, the ACK/NACK may be multiplexed with the transport blocks that carry the data, but not the CQI-only transmissions. In yet another example, the ACK/NACK can be multiplexed with both transport blocks. Similar options may be used for multiplexing RI with other transmissions. In examples, where QPSK modulation is used for the CQI-only transmissions, it can be advantageous to multiplex ACK/NACK and RI on the transport block(s) that carry the CQI-only transmissions.

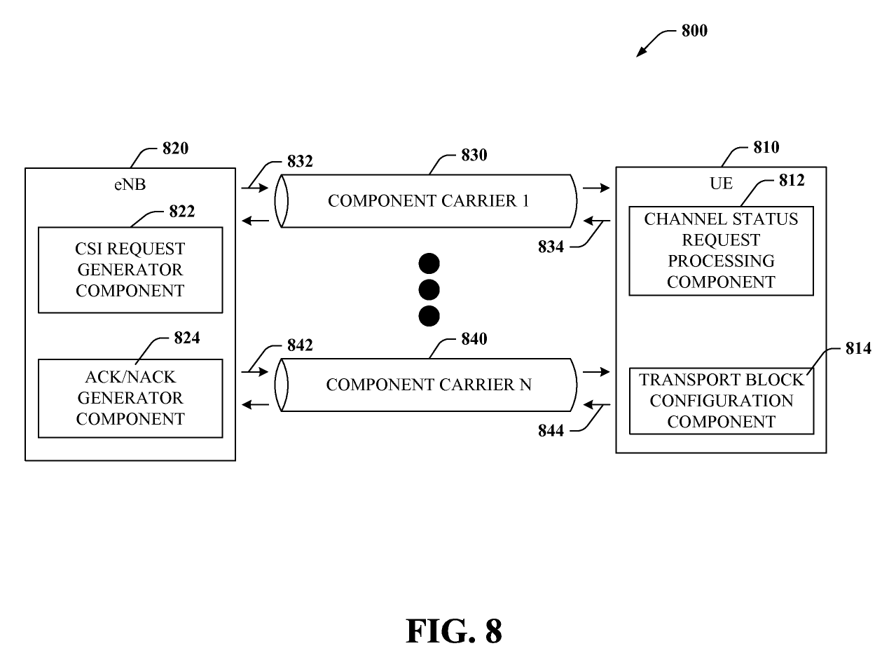

FIG. 8 illustrates a system 800 that can accommodate the disclosed embodiments. The system 800 can include a user equipment 810, which can communicate with an eNodeB (eNB) 820 (e.g., a base station, access point, etc.). While only one user equipment 810 and one eNB 820 are illustrated in FIG. 8, it is to be appreciated that the system 800 can include any number of user equipment 810 and/or eNBs 820. The eNB 820 can transmit information to the user equipment 810 over a forward link 832, 842 or downlink channel. In addition, the user equipment 810 can transmit information to the eNB 820 over a reverse link 834, 844 or uplink channel. In describing the various entities of FIG. 8, as well as other figures associated with the disclosed embodiments, for the purposes of explanation, the nomenclature associated with a 3GPP LTE or LTE-A wireless network is used. However, it is to be appreciated that the system 800 can operate in other networks such as, but not limited to, an OFDMA wireless network, a CDMA network, a 3GPP2 CDMA2000 network, and the like.

In LTE-A based systems, the user equipment 810 can be configured with multiple component carriers utilized by the eNB 820 to enable a wider overall transmission bandwidth. As illustrated in FIG. 8, the user equipment 810 can be configured with “component carrier 1” 830 through “component carrier N” 840, where N is an integer greater than or equal to one. While FIG. 8 depicts two component carriers, it is to be appreciated that the user equipment 810 can be configured with any suitable number of component carriers and, accordingly, the subject matter disclosed herein and claims are not limited to two component carriers. In one example, some of the multiple component carriers can be LTE Rel-8 carriers. Thus, some of the component carrier can appear as an LTE carrier to a legacy (e.g., an LTE Rel-8 based) user equipment. Each component carrier 830 through 840 can include respective downlinks 832 and 842 as well as respective uplinks 834 and 844.

FIG. 8 also illustrates that the eNodeB 820 includes a CSI request generator component 822, which can be configured to generate a request for an aperiodic channel status report. The eNodeB 820 of FIG. 8 also includes an ACK/NACK generator component 824, which can generate the necessary acknowledgments in response to received data and information. The user equipment 810 is depicted in FIG. 8 as including a channel status request processing component 812. The channel status request processing component 812 processes a channel status request that is received via a downlink channel 842, 832. The user equipment 810 of FIG. 8 also includes a transport block configuration component 814 that configures two transport blocks for the transmission of CSI and data. It should be noted the user equipment 810 and the eNodeB 820 of FIG. 8 also include other components, such as a processor, a memory unit, a receiver/transmitter, and the like, that are not explicitly shown in FIG. 8.

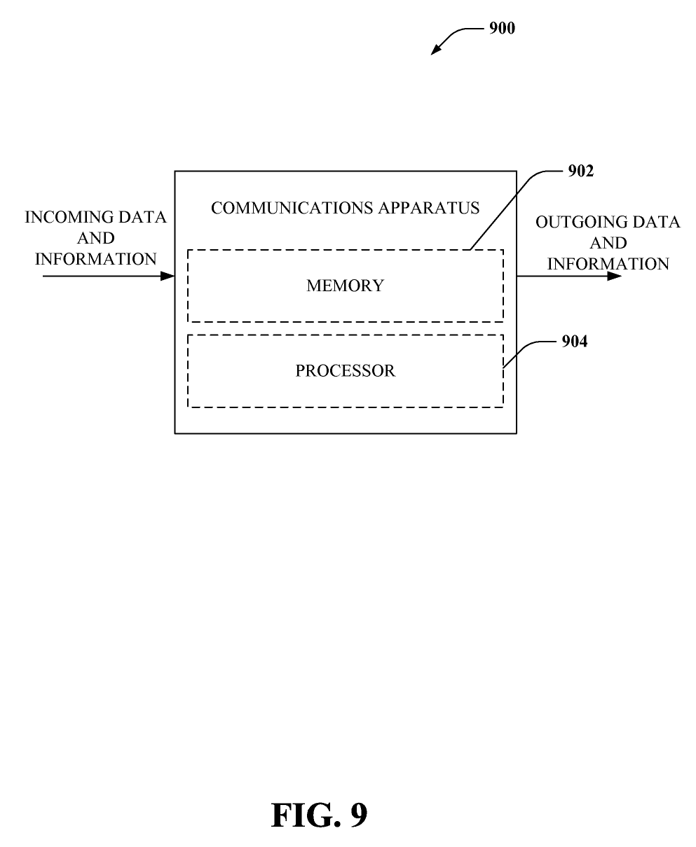

FIG. 9 illustrates an apparatus 900 within which the various disclosed embodiments may be implemented. In particular, the apparatus 900 that is shown in FIG. 9 may comprise at least a portion of a base station or at least a portion of a user equipment (such as the eNodeB 820 and the user equipment 810 that are depicted in FIG. 8) and/or at least a portion of a transmitter system or a receiver system (such as the transmitter system 210 and the receiver system 250 that are depicted in FIG. 2). The apparatus 900 of FIG. 9 can be resident within a wireless network and receive incoming data via, for example, one or more receivers and/or the appropriate reception and decoding circuitry (e.g., antennas, transceivers, demodulators and the like). The apparatus 900 of FIG. 9 can also transmit outgoing data via, for example, one or more transmitters and/or the appropriate encoding and transmission circuitry (e.g., antennas, transceivers, modulators and the like). Additionally, or alternatively, the apparatus 900 that is depicted in FIG. 9 may be resident within a wired network.

FIG. 9 further illustrates that the apparatus 900 can include a memory 902 that can retain instructions for performing one or more operations, such as signal conditioning, analysis and the like. Additionally, the apparatus 900 of FIG. 9 may include a processor 904 that can execute instructions that are stored in the memory 902 and/or instructions that are received from another device. The instructions can relate to, for example, configuring or operating the apparatus 900 or a related communications apparatus. It should be noted that while the memory 902 that is depicted in FIG. 9 is shown as a single block, it may comprise two or more separate memories that constitute separate physical and/or logical units. In addition, the memory while being communicatively connected to the processor 904, may reside fully or partially outside of the apparatus 900 that is depicted in FIG. 9. It is also to be understood that one or more components, such as the timing advance generation component 812, the timing misalignment processing component 816 and the time tracking loop 818 that are shown in FIG. 8, can exist within a memory such as memory 902.

It will be appreciated that the memories that are described in connection with the disclosed embodiments can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM) or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM) and direct Rambus RAM (DRRAM).

It should also be noted that the apparatus 800 of FIG. 9 can be employed with a user equipment or mobile device, and can be, for instance, a module such as an SD card, a network card, a wireless network card, a computer (including laptops, desktops, personal digital assistants PDAs), mobile phones, smart phones or any other suitable terminal that can be utilized to access a network. The user equipment accesses the network by way of an access component (not shown). In one example, a connection between the user equipment and the access components may be wireless in nature, in which access components may be the base station and the user equipment is a wireless terminal. For instance, the terminal and base stations may communicate by way of any suitable wireless protocol, including but not limited to Time Divisional Multiple Access (TDMA), Code Division Multiple Access (CDMA), Frequency Division Multiple Access (FDMA), Orthogonal Frequency Division Multiplexing (OFDM), FLASH OFDM, Orthogonal Frequency Division Multiple Access (OFDMA) or any other suitable protocol.

Access components can be an access node associated with a wired network or a wireless network. To that end, access components can be, for instance, a router, a switch and the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

It is to be understood that the embodiments and features that are described herein may be implemented by hardware, software, firmware or any combination thereof. Various embodiments described herein are described in the general context of methods or processes, which may be implemented in one embodiment by a computer program product, embodied in a computer-readable medium, including computer-executable instructions, such as program code, executed by computers in networked environments. As noted above, a memory and/or a computer-readable medium may include removable and non-removable storage devices including, but not limited to, Read Only Memory (ROM), Random Access Memory (RAM), compact discs (CDs), digital versatile discs (DVD) and the like. Therefore, the disclosed embodiments can be implemented as program code on a variety of non-transitory computer-readable media. When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Generally, program modules may include routines, programs, objects, components, data structures, etc., that perform particular tasks or implement particular abstract data types. Computer-executable instructions, associated data structures and program modules represent examples of program code for executing steps of the methods disclosed herein. The particular sequence of such executable instructions or associated data structures represents examples of corresponding acts for implementing the functions described in such steps or processes.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions and so on) that perform the functions described herein. The software codes may be stored in memory units and executed by processors. The memory unit may be implemented within the processor and/or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., user equipment-to-user equipment) ad hoc network systems often using unpaired unlicensed spectrums, 802.xx wireless LAN, BLUETOOTH and any other short- or long-range, wireless communication techniques.

Single carrier frequency division multiple access (SC-FDMA), which utilizes single carrier modulation and frequency domain equalization is a technique that can be utilized with the disclosed embodiments. SC-FDMA has similar performance and essentially a similar overall complexity as those of OFDMA systems. SC-FDMA signal has lower peak-to-average power ratio (PAPR) because of its inherent single carrier structure. SC-FDMA can be utilized in uplink communications where lower PAPR can benefit a user equipment in terms of transmit power efficiency.

Moreover, various aspects or features described herein may be implemented as a method, apparatus or article of manufacture using standard programming and/or engineering techniques. The term “article of manufacture” as used herein is intended to encompass a computer program accessible from any computer-readable device, carrier or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an ASIC. Additionally, the ASIC may reside in a user equipment (e.g. 810 FIG. 8). In the alternative, the processor and the storage medium may reside as discrete components in a user equipment (e.g., 810 FIG. 8). Additionally, in some embodiments, the steps and/or actions of a method or algorithm may reside as one or any combination or set of codes and/or instructions on a machine readable medium and/or computer readable medium, which may be incorporated into a computer program product.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method, comprising:
configuring two transport blocks for transmission of information in a wireless communication system in response to a downlink control information message comprising a request for a channel status report; and
transmitting channel status information using at least one of the transport blocks, wherein the at least one of the transport blocks contains only control information.

2. The method of claim 1, wherein
the transport blocks are associated with a physical uplink shared channel (PUSCH) of the wireless communication system.

3. The method of claim 1, wherein the channel status information comprises at least one of a channel quality indicator (CQI), a rank indicator (RI) and a precoding matrix indicator (PMI).

4. The method of claim 1, wherein one of the two transport blocks is configured for the transmission of channel status information and the remaining transport block is configured for data transmission.

5. The method of claim 4, wherein
the data is transmitted in the remaining transport block;
a positive acknowledgment (ACK) or a negative acknowledgment (NACK) is received in response to the transmission of data; and
no acknowledgment is associated with the transmission of channel status information.

6. The method of claim 4, wherein
a positive acknowledgment (ACK) or a negative acknowledgment (NACK) is received in response to the transmission of data; and
a positive acknowledgment (ACK) is received in response to the transmission of channel status information.

7. The method of claim 1, wherein one of the two transport blocks is configured for the transmission of channel status information and the remaining transport block is disabled.

8. The method of claim 7, wherein no acknowledgment is associated with the transmission of channel status information.

9. The method of claim 1, wherein both transport blocks are configured for the transmission of channel status information.

10. The method of claim 9, wherein no acknowledgment is associated with the transmission of channel status information.

11. The method of claim 1, wherein the request is signaled using an indication comprising at least one of:
a channel quality indicator value;
a modulation and coding scheme indicator value;
a number of resource blocks that are configured for uplink transmission;
a new indicator value; and
a redundancy version value.

12. The method of claim 1, wherein the number of resource blocks is selected from a group consisting of:
less than or equal to four resource blocks; and
more than four resource blocks.

13. The method of claim 1, wherein the channel status information is transmitted using a configuration selected from a group consisting of:
a beam forming configuration;
a transmission diversity configuration;
a multi-user multiple-input multiple-output (MU-MIMO) configuration; and
a single-user multiple-input multiple-output (SU-MIMO) configuration.

14. The method of claim 1, further comprising:
determining a first power adjustment value associated with uplink data transmissions;
determining a second power adjustment value associated with the channel status information transmissions; and
combining the first and the second power adjustment values to produce an overall power adjustment value for uplink transmissions.

15. The method of claim 1, further comprising:
generating a hybrid automatic repeat request (HARQ) feedback in response to data received in a downlink transmission; and
transmitting the HARQ feedback with the channel status information using the at least on of the transport blocks.

16. A device, comprising:
a processor; and
a memory, including processor executable code, the processor executable code, when executed by the processor, configures the device to:
configure two transport blocks for transmission of information in a wireless communication system in response to a downlink control information message comprising a request for a channel status report; and
transmit channel status information using at least one of the transport blocks, wherein the at least one of the transport blocks contains only control information.

17. The device of claim 16, wherein
the transport blocks are associated with a physical uplink shared channel (PUSCH) of the wireless communication system.

18. The device of claim 16, wherein the channel status information comprises at least one of a channel quality indicator (CQI), a rank indicator (RI) and a precoding matrix indicator (PMI).

19. The device of claim 16, wherein one of the two transport blocks is configured for the transmission of channel status information and the remaining transport block is configured for data transmission.

20. The device of claim 19, wherein no acknowledgment associated with transmission of the channel status information, and the processor executable code, when executed by the processor, configures the device to:
transmit the data in the remaining transport block; and
receive a positive acknowledgment (ACK) or a negative acknowledgment (NACK) in response to the transmission of data.

21. The device of claim 19, wherein the processor executable code, when executed by the processor, configures the device to:
receive a positive acknowledgment (ACK) or a negative acknowledgment (NACK) in response to the transmission of data; and
receive a positive acknowledgment (ACK) in response to the transmission of channel status information.

22. The device of claim 16, wherein one of the two transport blocks is configured for the transmission of channel status information and the remaining transport block is disabled.

23. The device of claim 22, wherein no acknowledgment is associated with the transmission of channel status information.

24. The device of claim 16, wherein both transport blocks are configured for the transmission of channel status information.

25. The device of claim 24, wherein no acknowledgment is associated with the transmission of channel status information.

26. The device of claim 16, wherein the processor executable code, when executed by the processor, configures the device to receive the request signaled using an indication comprising at least one of:
a channel quality indicator value;
a modulation and coding scheme indicator value;
a number of resource blocks that are configured for uplink transmission;
a new indicator value; and
a redundancy version value.

27. The device of claim 16, wherein the number of resource blocks is selected from a group consisting of:
less than or equal to four resource blocks; and
more than four resource blocks.

28. The device of claim 16, wherein the processor executable code, when executed by the processor, configures the device to transmit the channel status information using a configuration selected from a group consisting of:
a beam forming configuration;
a transmission diversity configuration;
a multi-user multiple-input multiple-output (MU-MIMO) configuration; and
a single-user multiple-input multiple-output (SU-MIMO) configuration.

29. The device of claim 16, wherein the processor executable code, when executed by the processor, configures the device to:
determine a first power adjustment value associated with uplink data transmissions;
determine a second power adjustment value associated with the channel status information transmissions; and
combine the first and the second power adjustment values to produce an overall power adjustment value for uplink transmissions.

30. The device of claim 16, wherein the processor executable code, when executed by the processor, configures the device to:
generate a hybrid automatic repeat request (HARQ) feedback in response to data received in a downlink transmission; and
transmit the HARQ feedback with the channel status information using the at least on of the transport blocks.

31. A device, comprising:
means for configuring two transport blocks for transmission of information in a wireless communication system in response to a downlink control information message comprising a request for a channel status report; and
means for transmitting channel status information using at least one of the transport blocks, wherein the at least one of the transport blocks contains only control information.

32. A computer program product, embodied on a non-transitory computer readable medium, comprising:
program code for configuring two transport blocks for transmission of information in a wireless communication system in response to a downlink control information message comprising a request for a channel status report; and
program code for transmitting channel status information using at least one of the transport blocks, wherein the at least one of the transport blocks contains only control information.

33. A method, comprising:
generating a request for the transmission of channel status information associated with a user equipment in a wireless communication system, wherein upon the reception of the request in a downlink control information message the user equipment is triggered to:
configure two transport blocks for transmission of the channel status information; and
transmit channel status information using at least one of the transport blocks, wherein the at least one of the transport blocks contains only control information; and
transmitting the request to the user equipment.

34. The method of claim 33, wherein
the transport blocks are associated with a physical uplink shared channel (PUSCH) of the wireless communication system.

35. The method of claim 33, wherein the channel status information comprises at least one of a channel quality indicator (CQI), a rank indicator (RI) and a precoding matrix indicator (PMI).

36. The method of claim 33, wherein
the channel status information is received from a transmission on one of the two transport blocks; and
data is received from a transmission on the remaining transport block.

37. The method of claim 36, further comprising:
transmitting a positive acknowledgment (ACK) or a negative acknowledgment (NACK) in response to the reception of data, wherein no acknowledgment is associated with the reception of channel status information.

38. The method of claim 36, further comprising:
transmitting a positive acknowledgment (ACK) or a negative acknowledgment (NACK) in response to the reception of data; and
transmitting a positive acknowledgment (ACK) in response to the reception of channel status information.

39. The method of claim 33, wherein one of the two transport blocks is configured for the transmission of channel status information and the remaining transport block is disabled.

40. The method of claim 33, wherein both transport blocks are configured for the transmission of channel status information.

41. The method of claim 33, wherein the request is signaled using an indication comprising at least one of:
a channel quality indicator value;
a modulation and coding scheme indicator value;
a number of resource blocks that are configured for uplink transmission;
a new indicator value; and
a redundancy version value.

42. The method of claim 41, wherein the number of resource blocks is selected from a group consisting of:
less than or equal to four resource blocks; and
more than four resource blocks.

43. The method of claim 33, wherein the channel status information is received using a configuration selected from a group consisting of:
a beam forming configuration;
a transmission diversity configuration;
a multi-user multiple-input multiple-output (MU-MIMO) configuration; and
a single-user multiple-input multiple-output (SU-MIMO) configuration.

44. A device, comprising:
a processor; and
a memory, including processor executable code, the processor executable code, when executed by the processor, configures the device to:
generate a request for the transmission of channel status information associated with a user equipment in a wireless communication system, wherein upon the reception of the request in a downlink control information message the user equipment is triggered to:
configure two transport blocks for transmission of the channel status information; and
transmit channel status information using at least one of the transport blocks, wherein the at least one of the transport blocks contains only control information; and
transmit the request to the user equipment.

45. The device of claim 44, wherein
the transport blocks are associated with a physical uplink shared channel (PUSCH) of the wireless communication system.

46. The device of claim 44, wherein the channel status information comprises at least one of a channel quality indicator (CQI), a rank indicator (RI) and a precoding matrix indicator (PMI).

47. The device of claim 44, wherein the processor executable code, when executed by the processor, configures the device to:
receive the channel status information from a transmission on one of the two transport blocks; and
receive data from a transmission on the remaining transport block.

48. The device of claim 47, wherein the processor executable code, when executed by the processor, configures the device to:
transmit a positive acknowledgment (ACK) or a negative acknowledgment (NACK) in response to the reception of data, wherein no acknowledgment is associated with the reception of channel status information.

49. The device of claim 47, wherein the processor executable code, when executed by the processor, configures the device to:
transmit a positive acknowledgment (ACK) or a negative acknowledgment (NACK) in response to the reception of data; and
transmit a positive acknowledgment (ACK) in response to the reception of channel status information.

50. The device of claim 44, wherein one of the two transport blocks is configured for the transmission of channel status information and the remaining transport block is disabled.

51. The device of claim 44, wherein both transport blocks are configured for the transmission of channel status information.

52. The device of claim 44, wherein the processor executable code, when executed by the processor, configures the device to generate the request that is signaled using an indication comprising at least one of:
a channel quality indicator value;
a modulation and coding scheme indicator value;
a number of resource blocks that are configured for uplink transmission;
a new indicator value; and
a redundancy version value.

53. The device of claim 52, wherein the number of resource blocks is selected from a group consisting of:
less than or equal to four resource blocks; and
more than four resource blocks.

54. The device of claim 44, wherein the processor executable code, when executed by the processor, configures the device to receive the channel status information using a configuration selected from a group consisting of:
a beam forming configuration;
a transmission diversity configuration;
a multi-user multiple-input multiple-output (MU-MIMO) configuration; and
a single-user multiple-input multiple-output (SU-MIMO) configuration.

55. A device, comprising:
means for generating a request for the transmission of channel status information associated with a user equipment in a wireless communication system, wherein upon the reception of the request in a downlink control information message the user equipment is triggered to:
configure two transport blocks for transmission of the channel status information; and
transmit channel status information using at least one of the transport blocks, wherein the at least one of the transport blocks contains only control information; and
means transmitting the request to the user equipment.

56. A computer program product, embodied on a non-transitory computer readable medium, comprising:
program code for generating a request for the transmission of channel status information associated with a user equipment in a wireless communication system, wherein upon the reception of the request in a downlink control information message the user equipment is triggered to:
configure two transport blocks for transmission of the channel status information; and
transmit channel status information using at least one of the transport blocks, wherein the at least one of the transport blocks contains only control information; and
program code for transmitting the request to the user equipment.
